(19) United States
(12) Patent Application Publication
(10) Pub. No.: US 2007/0215198 A1
(43) Pub. Date: Sep. 20, 2007

(54) Solar cell system with thermal management

(75) Inventors: Yirong Jiang, Manchester, CT (US); Yu Chen, East Hartford, CT (US); Satyam Bendapudi, Manchester, CT (US); Thomas Radcliff, Vernon, CT (US); Joseph Sangiovanni, West Suffield, CT (US); Yuhui Kuang, Shanghai (CN); Craig Walker, South Glastonbury, CT (US); Rakesh Radhakrishnan, Vernon, CT (US); Michael K. Sahm, Avon, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/376,818

(22) Filed: Mar. 16, 2006

(51) Int. Cl. H02N 6/00

(52) U.S. Cl. 136/246

(57) ABSTRACT

A thermally managed solar cell system includes a photovoltaic cell for generating electricity and heat. The system includes a housing, a base, and a heat removal device. The housing surrounds the solar cell system and has an open, rear portion. The base is positionable in the open portion of the housing and supports the photovoltaic cell. The base is also thermally conductive and spreads heat generated from the photovoltaic cell. The heat removal device and the base act as a single unit with the heat removal device being coupled to the base to remove the heat from the base.

### BACKGROUND OF THE INVENTION

Solar cells, or photovoltaic cells, have the ability to convert sunlight directly into electricity. Conventional solar cells are approximately 15 percent efficient in converting absorbed light into electricity. Concentrated photovoltaic cells have the ability to capture more of the electromagnetic spectrum and are thus more efficient, converting absorbed light into electricity at about 30 percent efficiency. The solar energy that is not converted to electricity is converted to heat that is subsequently discarded. Thus, more than 60 percent of the solar energy captured, in the form of heat, is wasted. Due to the small size and the high-energy absorption of the photovoltaic cells, the heat must be efficiently dissipated from the cells to prevent degradation or damage of the cells. One method of cooling the cell is to use a heat spreader to spread the heat generated in the cell, and then either passively or actively cool the cell by a heat sink or a heat exchanger, respectively. However, because active and passive cooling methods often require different constructions of the cell module assembly and are typically constructed with the cell module assembly, various constraints are imposed on the manufacturer regarding fixtures, tools, and equipment.

### BRIEF SUMMARY OF THE INVENTION

A thermally managed solar cell system includes a photovoltaic cell for generating electricity and heat. The system includes a housing, a base, and a heat removal device. The housing surrounds the solar cell system and has an open, rear portion. The base is positionable in the open portion of the housing and supports the photovoltaic cell. The base is also thermally conductive and spreads heat generated from the photovoltaic cell. The heat removal device and the base act as a single unit with the heat removal device being coupled to the base to remove the heat from the base.

### BRIEF DESCRIPTION OF THE DRAWINGS

FIG. 1A is a partial sectional view of a first embodiment of a solar cell system with a modular thermal management structure.

FIG. 1B is a partial sectional view of a second embodiment of a solar cell system with a modular thermal management structure.

FIG. 1C is a partial sectional view of a third embodiment of a solar cell system with a modular thermal management structure.

FIG. 1D is a partial sectional view of a fourth embodiment of a solar cell system with a modular thermal management structure.

FIG. 2A is a side cross-sectional view of a first embodiment of an active heat removal device.

FIG. 2B is a front cross-sectional view of the first embodiment of the active heat removal device.

FIG. 3A is a side cross-sectional view of a second embodiment of an active heat removal device.

FIG. 3B is a front cross-sectional view of the second embodiment of the active heat removal device.

FIG. 4A is a top view of a third embodiment of an active heat removal device.

FIG. 4B is a front cross-sectional view of the third embodiment of the active heat removal device.

FIG. 5 is a schematic diagram of an evaporator of a vapor compression system used in conjunction with a solar cell system.

### DETAILED DESCRIPTION

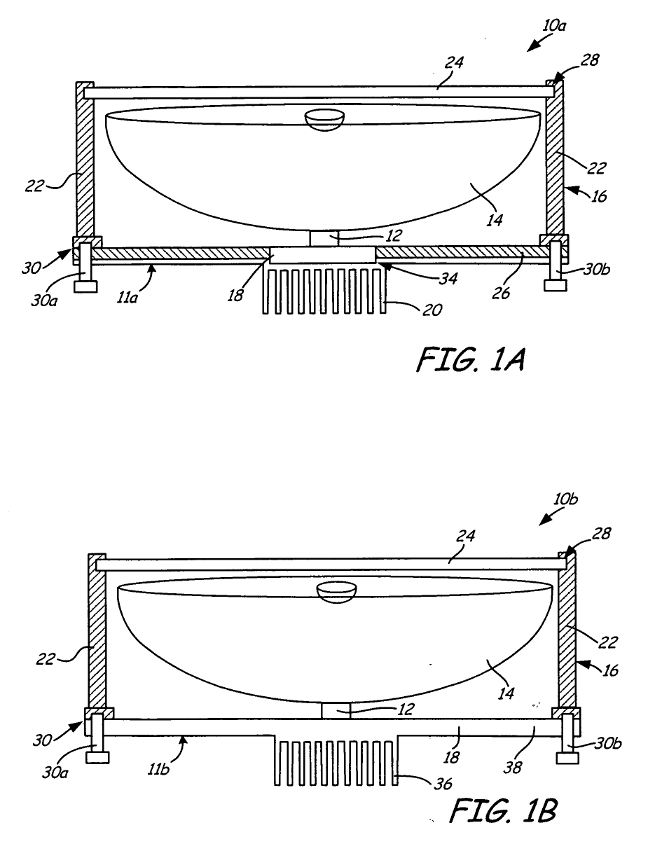

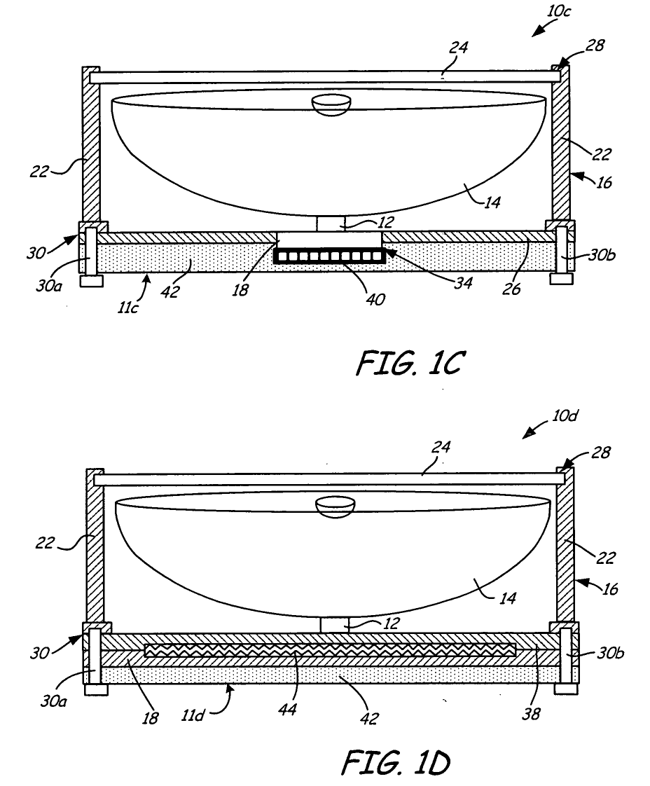

FIGS. 1A, 1B, 1C, and 1D show solar cell systems 10a, 10b, 10c, and 10d having modular thermal management structures 11a, 11b, 11c, and 11d, respectively. Solar cell systems 10a, 10b, 10c, and 10d are designed such that a passive cooling or an active cooling heat removal device attached to modular thermal management structures 11a, 11b, 11c, and 11d, respectively, can be easily integrated with a solar cell system after the solar cell system is already assembled. Solar cell systems 10a, 10b, 10c, and 10d are the same, with different modular thermal management structures 11a, 11b, 11c, and 11d, respectively. Solar cell systems 10a, 10b, 10c, and 10d thus increase manufacturing efficiency, allowing either simultaneous or separate integration of a heat removal device to a solar cell system.

FIG. 1A shows a front view of a first embodiment of solar cell system 10a having modular thermal management structure 11a. Solar cell system 10a generally includes photovoltaic cell 12, concentrator 14, and housing 16. Modular thermal management structure 11a utilizes passive cooling and generally includes removable base 18, and heat removal device 20. In operation, concentrator 14 is aligned with respect to the sun so that it collects and focuses a maximum amount of solar energy for the dimensions of concentrator 14. The solar energy, in the form of light, is absorbed by photovoltaic cell 12. Photovoltaic cell 12 subsequently converts the solar energy into electrical energy. The energy that is not used to generate electricity produces heat. Because photovoltaic cell 12 is generally between 10% and 40% efficient, approximately 60% of the energy absorbed into photovoltaic cell 12 is converted to heat. The heat must be dissipated from photovoltaic cell 12 to prevent damage and decreased performance of photovoltaic cell 12. This heat can also be recovered and used as thermal energy.

Housing 16 surrounds solar cell system 10a and supports concentrator 14. Housing 16 generally includes side frame 22, window 24, and base plate 26. Side frame 22 is positioned along the outer side perimeter of photovoltaic cell 12 and concentrator 14 and protects photovoltaic cell 12 and concentrator 14 from external elements. Window 24 is formed of a transparent glass and is connected to side frame 22 at top edge 28 of side frame 22. Window 24 is positioned above concentrator 14 and provides an enclosure to evacuate space for the optics of concentrator 14 as well as to protect photovoltaic cell 12 from damage from external sources. Base plate 26 provides the foundation of housing 16 and is attached to side frame 22 at bottom edge 30 of side frame 22 by fasteners 32a and 32b, allowing for quick and easy access to photovoltaic cell 12 if needed. Base plate 26 also includes aperture 34 in the center of base plate 26 to receive removable base 18 of modular thermal management structure 11a.

Modular thermal management structure 11a is connected to solar cell system 10a at housing 16. Removable base 18 is positioned directly beneath photovoltaic cell 12 and is formed from a lightweight sheet of highly thermally conductive material. Because removable base 18 is thermally conductive, removable base 18 also functions as a heat spreader for photovoltaic cell 12. Heat removal device 20 is connected to photovoltaic cell 12 by removable base 18. Thus, removable base 18 spreads the high heat flux (heat transfer rate per unit area) of photovoltaic cell 12 created by the high absorption of energy into the relatively small surface area of photovoltaic cell 12 by increasing the heat transfer area between photovoltaic cell 12 and heat removal device 20. By increasing the heat transfer area between photovoltaic cell 12 and heat removal device 20, the heat flux from photovoltaic cell 12 decreases. In one embodiment, removable base 18 is formed of aluminum.

Heat removal device 20 is directly attached to removable base 18 and passively dissipates the heat generated by photovoltaic cell 12 after the heat has spread through removable base 18. In one embodiment, heat removal device 20 is a heat sink. Heat sinks are typically used in combination with solar cell systems that are passively cooled. In passive cooling, ambient air is used as the heat transfer source, which cools the solar cell system by natural convection. Because the objective of a heat sink is to simply dissipate the excess heat, rather than capture the heat for subsequent use, no insulation is needed. Heat removal device 20 can be connected to housing 16 by removable base 18 by any means known in the art, including, but not limited to: brazing, welding, or mechanical means.

FIG. 1B shows a front view of a second embodiment of solar cell system 10b having heat removal device 36 integrated with modular thermal management structure 11b. Similar to modular thermal management structure 11a, modular thermal management structure 11b utilizes passive cooling to remove heat from photovoltaic cell 12. First and second embodiments of passive cooling modular thermal management structures 11a and 11b operate similarly to each other. The only difference between modular thermal management structures 11a and 11b is that heat removal device 36 of passive modular thermal management structure 11b is formed as an integral component of removable base 18. In one embodiment, base plate 26 and removable base 18 (shown in FIG. 1A) are designed as integrated base 38. Heat removal device 36 is subsequently formed with integrated base 38 as an integral component of modular thermal management structure 11b. Heat removal device 36 can be formed as a part of integrated base 38 by any means known in the art, including, but not limited to, brazing.

FIG. 1C shows a front view of a third embodiment of solar cell system 10c having heat removal device 40 attached to modular thermal management structure 11c. Modular thermal management structure 11c actively cools photovoltaic cell 12 and includes insulator 42. Modular thermal management structure 11c operates in the same manner as modular thermal management structure 11a, except that heat removal device 40 of modular thermal management structure 11c actively, rather than passively, cools photovoltaic cell 12. Active cooling systems are generally used to dissipate the heat from solar cell systems when the heat generated by the solar cell system is captured for use in the system or an adjoining process system. A coolant is typically used to capture and transport the heat dissipated from the solar cell system through forced convection. Alternatively, if heat removal device 40 is fully sealed, a phase change material can be used to capture and transport the heat. Examples of phase change materials include, but are not limited to: methanol, ammonia, water, and acetone. In the case that heat removal device 40 is fully sealed, modular thermal management structure 11c will passively dissipate heat from photovoltaic cell 12.

Because the heat from photovoltaic cell 12 is captured for subsequent use, modular thermal management structure 11c includes insulator 42 positioned between base plate 26, removable base 18, and heat removal device 40. Insulator 42 prevents heat generated from photovoltaic cell 12 from escaping into the environment, maximizing the heat transfer from photovoltaic cell 12 to the coolant and thus any heat supply to an adjoining process system. In one embodiment, heat removal device 40 is a heat exchanger.

FIG. 1D shows a front view of a fourth embodiment of solar cell system 10d having heat removal device 44 integrated with modular thermal management structure 11d. Similar to the third embodiment of modular thermal management structure 11c, the fourth embodiment of modular thermal management structure 11d also utilizes active cooling to remove heat from photovoltaic cell 12. The only difference between modular thermal management structures 11c and 11d is that heat removal device 44 is formed as a part of integrated base 38, similar to modular thermal management structure 11b. Heat removal device 44 can be formed as a part of integrated base 38 by any means known in the art. In one embodiment, a face of heat removal device 44 is brazed to integrated base 38. In this case, a coolant flows between the plates where it picks up the heat from photovoltaic cell 12 for potential use. Alternatively, similar to modular thermal management structure 11c, if heat removal device 44 is fully sealed, a phase change material can be used to capture and transport the heat.

Although FIGS. 1A-1D depict solar cell systems 10a-10d, respectively, as including only one photovoltaic cell 12, solar cell systems 10a-10d can include several photovoltaic cells 12 within housing 16. Additionally, although FIGS. 1A-1D depict concentrator 14 as resting directly on top of photovoltaic cell 12, concentrator 14 only needs to be placed proximate to photovoltaic cell 12 and does not need to be in direct contact with photovoltaic cell 12 to be effective.

In operation, photovoltaic cell 12, base 26, and modular thermal management structures 11a-11d can be separated from housing 16 of solar cell systems 10a-10d, respectively, by removing fasteners 32a and 32b. Depending on the desired function of the heat collected from solar cell systems 10a-10d, the heat removal device can be designed to perform passive or active cooling. However, solar cell system 10a-10d will remain the same, allowing for easy installation and replacement of modular thermal management structures 11a-11d, depending on the particular needs and expectations of solar cell systems 10a-10d. For example, various heat removal device embodiments can be utilized to actively cool photovoltaic cell 12, as described below. One type of heat removal device includes a plurality of hemispherical blocks positioned below the photovoltaic cells to reduce the local heat flux of the photovoltaic cells. Another type of heat removal device includes a plurality of microchannels that extend beneath the photovoltaic cells to increase the surface area between the photovoltaic cells and the heat transfer fluid. Yet another type of heat removal device includes positioning a vapor compression system below the solar system. All of these active heat removal devices use coolants to dissipate the heat from the photovoltaic cells.

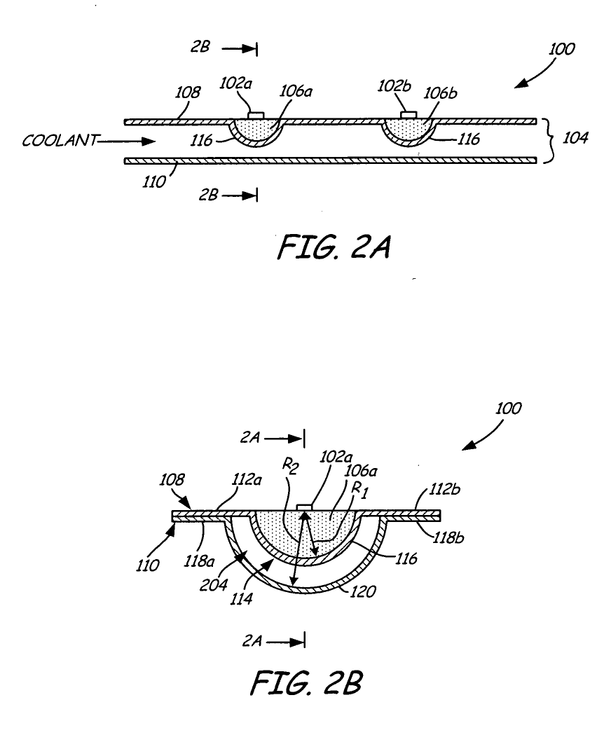

FIGS. 2A and 2B show a side cross-sectional view and a front cross-sectional view, respectively, of a first embodiment of active heat removal device 100 and will be discussed in conjunction with one another. Heat removal device 100 actively cools photovoltaic cells 102a and 102b of a solar cell system connected to heat removal device 100 and generally includes channel 104 and blocks 106a and 106b. Due to the small size of photovoltaic cells 102a and 102b and the high solar energy concentration ratio entering photovoltaic cells 102a and 102b, the local heat flux is extremely high. Active heat removal device 100 provides effective heat removal from photovoltaic cells 102a and 102b while maintaining a low temperature difference between photovoltaic cells 102a and 102b and the coolant flowing through channel 104. Although FIGS. 2A and 2B depict only two photovoltaic cells 102a and 102b and two respective blocks 106a and 106b, active heat removal device 100 can have any number of blocks as necessary to efficiently cool the photovoltaic cells positioned along channel 104.

Channel 104 acts as a coolant flow passage and is formed from contact plate 108 and bottom plate 110. As can be seen in FIG. 2B, contact plate 108 has a first side 112a, a second side 112b, and a central portion 114 between first and second sides 112a and 112b. A plurality of hemispherical recesses 116 having a radius R₁ are formed along the length of central portion 114. Bottom plate 110 also has a first side 118a, a second side 118b, and a central portion 120 between first and second sides 118a and 118b. Central portion 120 of bottom plate 110 forms a semi-cylindrical shape with a radius R₂ along the entire length of bottom plate 110. Radius R₂ of central portion 120 is greater than radius R₁ of hemispherical recesses 116.

Contact plate 108 and bottom plate 110 are connected together to form channel 104. First side 112a of contact plate 108 is connected to first side 118a of bottom plate 110, and second side 112b of contact plate 108 is connected to second side 118b of bottom plate 110. Although FIGS. 2A and 2B depict hemispherical recesses 116 of contact plate 108 as having hemispherical cross-sectional shapes and central portion 120 of bottom plate 110 as having a semi-cylindrical shape, hemispherical recesses 116 and central portion 120 can have any variety of cross-sectional shapes as long as together they form a coolant flow channel. Contact plate 108 and bottom plate 110 of channel 104 are formed of a highly conductive material, such as metal. An example of a particularly suitable metal is aluminum. Contact plate 108 and bottom plate 110 can be connected to each other by any means known in the art, including, but not limited to, brazing.

Blocks 106a and 106b have a hemispherical shape and are sized to rest within hemispherical recesses 116 of contact plate 108. Photovoltaic cells 102a and 102b are then positioned directly on blocks 106a and 106b, respectively, which act to reduce the local heat flux of photovoltaic cells 102a and 102b. Blocks 106a and 106b are formed from highly thermally conductive material and significantly increase the contact surface area between from photovoltaic cells 102a and 102b and the coolant flowing through channel 104. As the contact surface area between photovoltaic cells 102a and 102b and the coolant increases, the local heat flux decreases, minimizing potential damage to photovoltaic cells 102a and 102b. The hemispherical shape of blocks 106a and 106b cause the heat from photovoltaic cells 102a and 102b to be dissipated in a radial direction, evenly spreading the heat to a larger surface area and thus reducing the heat flux. Because blocks 106a and 106b and channel 104 are both formed of highly conductive material, any temperature difference between photovoltaic cells 102a and 102b and blocks 106a and 106b will be minimal. Although blocks 106a and 106b are depicted in FIGS. 2A and 2B as having a hemispherical shape, blocks 106a and 106b can be any variety of shapes as long as they are capable of resting in recesses 116. In one embodiment, blocks 106a and 106b are formed of aluminum and can be integral to contact plate 108 or be brazed onto contact plate 108. Photovoltaic cells 102a and 102b can subsequently be brazed on top of blocks 106a and 106b, respectively.

In operation, a coolant passes through channel 104 of active heat removal device 100 and acts as a heat transfer fluid for the heat being dissipated from photovoltaic cells 102a and 102b. The heat from photovoltaic cells 102a and 102b is first dissipated into blocks 106a and 106b, respectively, and then radiates in a radial direction through blocks 106a and 106b to contact plate 108. This increased contact surface area created by blocks 106a and 106b and recesses 116 of contact plate 108 allows heat transfer from photovoltaic cells 102a and 102b to the coolant flowing through channel 104 with significantly reduced heat flux, thus avoiding localized boiling of the coolant. This increased heat transfer contact surface area also allows heat to be dissipated from photovoltaic cells 102a and 102b without a large temperature drop. As a result of the small temperature difference between photovoltaic cells 102a and 102b and the coolant, useful heat can be generated from photovoltaic cells 102a and 102b, such as heated water.

To integrate heat removal device 100 with solar cell systems 10c or 10d, contact plate 108 of heat removal device 100 acts as removable base 18. Contact plate 108 is attached to housing 16 by fasteners 32a and 32b with channel 104 and blocks 106a and 106b removing the heat from photovoltaic cells 102a and 102b.

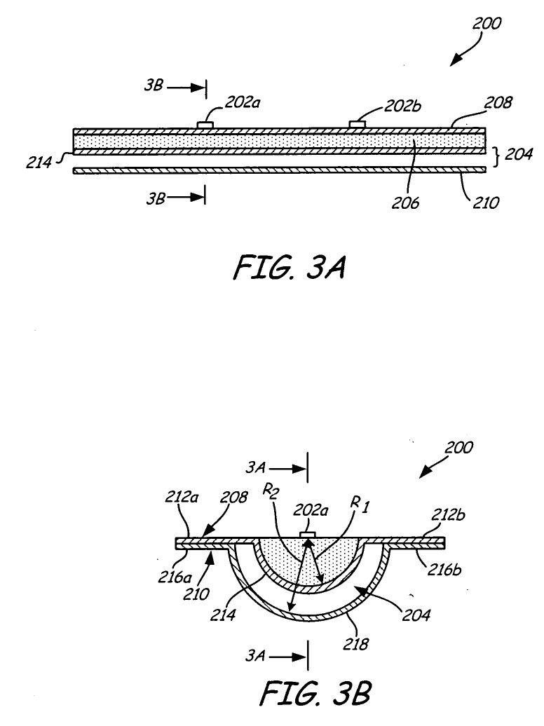

FIGS. 3A and 3B show a side cross-sectional view and a front cross-sectional view, respectively, of a second embodiment of active heat removal device 200 and will be discussed in conjunction with one another. Active heat removal device 200 dissipates the heat from photovoltaic cells 202a and 202b and generally includes channel 204 and block 206. Channel 204 includes contact plate 208 and bottom plate 210. Contact plate 208 has first and second sides 212a and 212b and a central portion 214 between first and second sides 212a and 212b. Likewise, bottom plate 210 has a first side 216a and a second side 216b and a central portion 218 between first and second sides 216a and 216b. Photovoltaic cells 202a and 202b, channel 204, and block 206 of active heat removal device 200 interact and function in the same manner as photovoltaic cells 102a and 102b, channel 104, and blocks 106a and 106b of active heat removal device 100 (shown in FIGS. 2A and 2B), except that central portion 214 of contact plate 208 is formed with continuous groove 220 along the length of channel 204, rather than with a plurality of hemispherical recesses. Additionally, block 206 is a continuous block that extends the length of channel 204, rather than a plurality of blocks.

By forming groove 220 along the entire length of contact plate 208 and positioning block 206 within the entire length of groove 212, the cross-sectional area of channel 204 remains constant along the entire length of channel 204. This results in an more constant rate of heat transfer along channel 204 of active heat removal device 200 compared to the rate of heat transfer in channel 104 of active heat removal device 100. The rate of heat transfer in channel 104 is smaller and less consistent due to the intermittent contact surface areas between blocks 106a and 106b and the coolant. Because block 206 provides heat transfer along the entire length of channel 204, the heat transfer of active heat removal device 200 is more uniform and can be more easily controlled.

To integrate heat removal device 200 with solar cell systems 10c or 10d, contact plate 208 of heat removal device 200 acts as removable base 18. Contact plate 208 is attached to housing 16 by fasteners 32a and 32b with channel 204 and block 206 removing the heat from photovoltaic cells 202a and 202b.

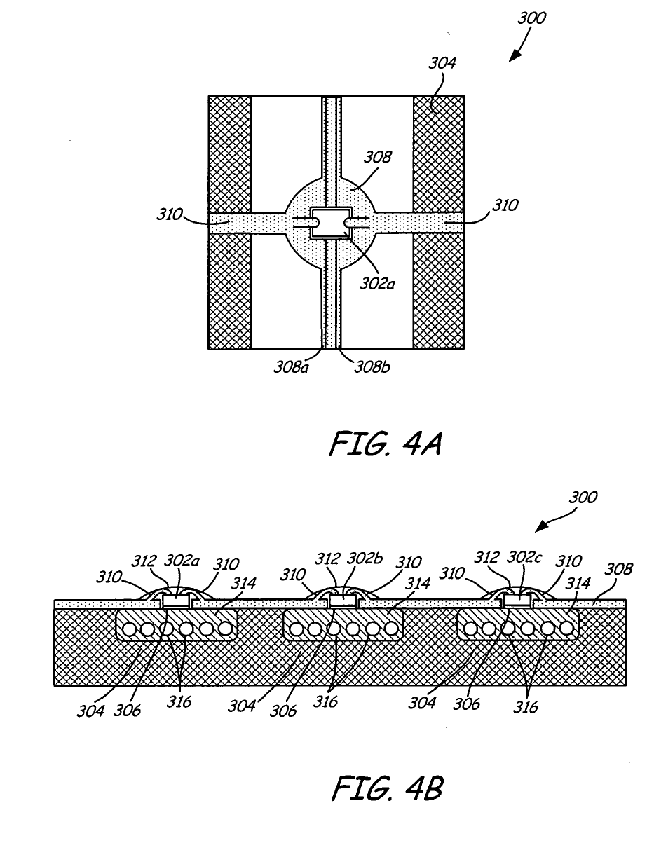

FIGS. 4A and 4B show a top view and a front cross-sectional view of a third embodiment, respectively, of active heat removal device 300 and will be discussed in conjunction with one another. Active heat removal device 300 dissipates heat from photovoltaic cells 302a, 302b, and 302c and generally includes base 304, coating 306, substrate 308, leaf springs 310, covercoat 312, and heat exchangers 314. As with first and second embodiments of active heat removal devices 100 and 200 (shown in FIGS. 2A and 2B, and FIGS. 3A and 3B, respectively), coolant is passed through microchannels 314 and serves as a heat transfer fluid. Although FIG. 4A depicts only photovoltaic cell 302a and FIG. 4B depicts only three photovoltaic cells 302a, 302b, and 302c, active heat removal device 300 can cool any number of photovoltaic cells in contact with active heat removal device 300.

Base 304 is an insulated structural base that supports photovoltaic cells 302a, 302b, and 302c, substrate 308, and heat exchanger 314. Substrate 308 is a thin film and forms the foundation at which the electrical circuit is laid out. Apertures must first be cut out from substrate 308 such that photovoltaic cells 302a, 302b, and 302c can be mounted directly on base 304 without overlapping substrate 308 once photovoltaic cells 302a, 302b, and 302c are ready to be mounted. In one embodiment, the apertures are cut from substrate 308 such that portions of substrate 308 will overlap edges of photovoltaic cells 302a, 302b, and 302c when photovoltaic cells 302a, 302b, and 302c are mounted to base 304. After the apertures have been cut from substrate 308, substrate 308 is mounted on base 304.

Once substrate 308 is in place, photovoltaic cells 302a, 302b, and 302c are mounted and mechanically attached to base 304. As shown in FIG. 4B, photovoltaic cells 302a, 302b, and 302c are positioned equidistant from each other along base 304. Each of photovoltaic cells 302a, 302b, and 302c is coated with a thin layer of coating 306 on the surface of photovoltaic cells 302a, 302b, and 302c that contacts base 304. Coating 306 is a highly thermally conducting and electrically insulating material, such as aluminum nitride, which acts as an interface layer between photovoltaic cells 302a, 302b, and 302c and base 304. In one embodiment, photovoltaic cells 302a, 302b, and 302c are pressed and held onto base 304 by leaf springs 310. Leaf springs 310 are the portions of substrate 308 that were originally cut to overlap photovoltaic cells 302a, 302b, and 302c. Leaf springs 310 function to maintain edge portions of photovoltaic cells 302a, 302b, and 302c to base 304.

Substrate 308 is electrically insulated and has a power bus imprinted with two terminals 308a and 308b to connect each of photovoltaic cells 302a, 302b, and 302c to substrate 308 and to transfer power from photovoltaic cells 302a, 302b, and 302c to a connector. Because substrate 308 is electrically insulating, substrate 308 typically has low thermal conductivity, resulting in high heat transfer resistance across substrate 308. Low temperature coolants are thus needed to effectively remove heat from photovoltaic cells 302a, 302b, and 302c. Once photovoltaic cells 302a, 302b, and 302c have been mounted to base 304, covercoat 312 is coated over photovoltaic cells 302a, 302b, and 302c to protect photovoltaic cells 302a, 302b, and 302c from exposure. In one embodiment, covercoat 312 is silica gel.

Heat exchangers 314 have microchannels 316 and are housed within base 304. Heat exchangers 314 extend through the length of base 304 beneath photovoltaic cells 302a, 302b, and 302c. Microchannels 316 are extruded tubes designed to ensure high heat spreading along the wall of heat exchanger 314. The coolant flows through microchannels 314 and captures the heat generated from photovoltaic cells 302a, 302b, and 302c. Although FIGS. 4A and 4B depict heat exchanger 314 as a microchannel heat exchanger, heat exchanger 314 can be any type of heat exchanger, for example, a plate heat exchanger with flow channels.

In operation, microchannels 316 of heat exchanger 314 and highly thermally conductive coating 306 provide high convective heat transfer of heat generated by photovoltaic cells 302a, 302b, and 302c to the coolant flowing through microchannels 316. The high convective heat transfer results in efficient heat removal from photovoltaic cells 302a, 302b, and 302c. Due to the high heat transfer rate, heat is transferred to the coolant with a minimal temperature drop, resulting in a low temperature difference between photovoltaic cells 302a, 302b, and 302c and the coolant. Similar to active heat removal devices 100 and 200, useful heat can be generated from cells 302a, 302b, and 302c with active heat removal device 300. Additionally, due to the size and material of microchannels 316, microchannels 316 provide a low-cost and lightweight thermal management system, allowing for high volume production and reducing the mechanical load of active heat removal device 300.

To integrate heat removal device 300 with solar cell systems 10c or 10d, base 304 of heat removal device 300 acts as removable base 18. Base 304 is attached to housing 16 by fasteners 32a and 32b with microchannels 314 removing the heat from photovoltaic cells 302a, 302b, and 302c.

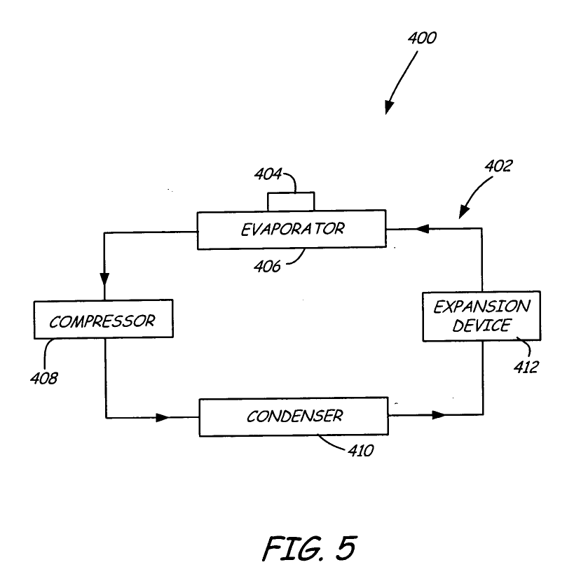

In a fourth embodiment, active heat removal device 400 is an evaporator of vapor compression system 402. Shown in FIG. 5, vapor-compression system 402 controls the temperature of solar cell system 404 and generally includes evaporator 406, compressor 408, condenser 410, and expansion device 412. A refrigerant flows through vapor compression system 402 and captures the heat generated from solar cell system 404, which contacts evaporator 406. The refrigerant can include, but is not limited to: chlorofluorocarbons, hydrofluorocarbons, hydrochlorofluorocarbons, carbon dioxide, propane, butane, alcohols, water, any zeotropic or azeotropic blends or mixtures, or any combination of the above.

Evaporator 406 and condenser 410 are heat exchangers that evaporate and condense the refrigerant, respectively. Evaporator 406 boils the refrigerant to provide cooling. As the refrigerant is boiled and evaporated in evaporator 406, the temperature and pressure are generally low, T_{low}, P_{low}. At this temperature, the refrigerant in evaporator 406 readily absorbs heat rejected from solar cell system 404. In addition, because the temperature of the refrigerant is low, it can act to cool an external source such as a refrigerator or an air conditioner.

Upon leaving evaporator 406, the refrigerant is sent to compressor 408. Compressor 408 takes the refrigerant vapors that were boiled from evaporator 406 and raises the pressure of the refrigerant vapor to a level P_{high} sufficient for the refrigerant vapor to condense in condenser 410. As the refrigerant is compressed and the pressure of the refrigerant increases, the temperature of the refrigerant also increases. At this stage, the refrigerant is a high pressure P_{high}, high temperature T_{high} fluid vapor.

Once the refrigerant has been compressed, it is sent to condenser 410, where the refrigerant is cooled to a liquid state that is still high pressure P_{high} and high temperature T_{high}. The heat is thus rejected from the refrigerant in condenser 410. Condenser 410 can be any design known in the art, including, but not limited to, a cooling tower or an evaporative condenser.

After leaving condenser 410, the refrigerant enters expansion device 412. Expansion device 412 controls the flow of the condensed refrigerant leaving condenser 410 at increased pressure P_{high} and increased temperature T_{high} into evaporator 406. Expansion device 412 lowers both the pressure and the temperature of the refrigerant to a low pressure P_{low} and a low temperature T_{low} prior to entering evaporator 406 for heat absorption. At this pressure and temperature, the refrigerant is a two-phase fluid, or a vapor/liquid mixture, which has better heat transfer properties than a single-phase fluid. Furthermore, the refrigerant generally stays at a constant temperature and pressure when boiling/evaporating. Use of evaporator 406 to absorb the heat allows better temperature control of photovoltaic cell 404. The refrigerant is passed continuously through vapor compression system 402 to remove heat from solar cell system 404.

To integrate heat removal device 400 with solar cell systems 10c or 10d, evaporator 406 of heat removal device 400 acts as removable base 18. Evaporator 406, which can be, for example, any of the above the first, second, and third embodiments of heat removal devices 100, 200, and 300, respectively, is attached to housing 16 by fasteners 32a and 32b and removes the heat from photovoltaic cells 302a, 302b, and 302c.

The solar cell systems attached to modular thermal management structures provide passive and active cooling modular configurations for removing heat from a solar cell system. Various modular structures are disclosed that allow connection of either a passive or an active cooling device to a photovoltaic cell subsequent to assembly of the solar cell system. A heat sink can be connected to the solar cell system either after the construction of a solar cell housing or integrally with the modular thermal management structure for a passive thermal management system. Likewise, a heat exchanger or other active cooling heat removal device as described below can be connected to the solar cell system either after construction of the solar cell housing or integrally with the modular thermal management structure for an active thermal management system.

Various active cooling heat removal devices can be used to effectively remove heat from the solar cell system. In one heat removal device, a plurality of blocks are positioned directly below photovoltaic cells of the solar cell system to reduce the local heat flux of the photovoltaic cells. In another heat removal device, a plurality of microchannels extend below the photovoltaic cells to increase the heat transfer from the photovoltaic cells to a heat transfer fluid. In yet another type of heat removal device, a vapor compression system is connected to the solar cell system. The active heat removal devices use a coolant as a heat transfer means to dissipate the heat from the photovoltaic cells.

Although the present invention has been described with reference to preferred embodiments, workers skilled in the art will recognize that changes may be made in form and detail without departing from the spirit and scope of the invention.

1. A thermally managed solar cell system having a photovoltaic cell for generating electricity and heat, the system comprising:
a housing surrounding the solar cell system, the housing having an open, bottom portion;
a base positionable in the open portion of the housing for supporting the photovoltaic cell, the base being thermally conductive for spreading heat from the photovoltaic cell; and
a heat removal device coupled to the base for removing the heat from the base, wherein the base and the heat removal device act as a single unit.

2. The system of claim 1, wherein the base is a heat spreader.

3. The system of claim 2, wherein the heat spreader is formed of a block having high thermal conductivity.

4. The system of claim 2, wherein the heat spreader is configured to reduce a heat flux of the photovoltaic cell.

5. The system of claim 1, wherein the heat removal device comprises a heat sink.

6. The system of claim 1, wherein the heat removal device comprises a heat exchanger.

7. The system of claim 6, wherein the heat exchanger comprises at least one microchannel positioned beneath the photovoltaic cell.

8. The system of claim 1, wherein the heat removal device is formed of a dielectric and thermally conductive material.

9. The system of claim 8, wherein the heat removal device is a block formed of aluminum for increasing a rate of heat transfer from the photovoltaic cell.

10. The system of claim 1, wherein the heat removal device comprises an evaporator of a vapor compression system.

11. The system of claim 1, and further comprising a heat transfer means for capturing and transporting the heat from the photovoltaic cell.

12. A thermally managed solar cell system having a concentrated photovoltaic cell, the solar cell system comprising:
a housing surrounding the concentrated photovoltaic cell, the housing having an aperture in a bottom surface of the housing and the concentrated photovoltaic cell being positioned immediately over the aperture; and
a modular thermal management structure mountable to the aperture of the housing and in direct contact with the concentrated photovoltaic cell for supporting the concentrated photovoltaic cell and spreading and dissipating heat generated by the concentrated photovoltaic cell.

13. The solar cell system of claim 12, wherein the modular thermal management structure comprises:
a base positioned in alignment with the bottom surface of the housing for spreading heat generated by the concentrated photovoltaic cell; and
a heat removal device coupled to the base for dissipating the heat from the base.

14. The solar cell system of claim 13, wherein a surface contact area between the concentrated photovoltaic cell and the modular thermal management structure is increased by the base.

15. The solar cell system of claim 13, wherein the heat removal device comprises a heat sink.

16. The solar cell system of claim 13, wherein the heat removal device comprises a heat exchanger.

17. The solar cell system of claim 16, wherein the heat exchanger comprises a coolant flow channel and a thermally conductive block for actively dissipating heat generated from the concentrated photovoltaic cell.

18. The solar cell system of claim 17, wherein the coolant flow channel is sealed.

19. The solar cell system of claim 18, wherein a phase change material flows through the coolant flow channel.

20. The solar cell system of claim 16, wherein the heat exchanger comprises a plurality of coolant flow microchannels and a thermally conductive coating for actively dissipating heat generated from the concentrated photovoltaic cell.
